(19) United States
(12) Patent Application Publication
(10) Pub. No.: US 2007/0187238 A1
(43) Pub. Date: Aug. 16, 2007

(54) Microelectrode system for neuro-stimulation and neuro-sensing and microchip packaging

(76) Inventors: John J. Whalen III, Davie, FL (US); James D. Weiland, Valencia, CA (US); Mark S. Humayun, Glendale, CA (US); Peter C. Searson, Baltimore, MD (US)

Correspondence Address: MCDERMOTT WILL & EMERY LLP, 28 STATE STREET, BOSTON, MA, 02109-1775, US

(21) Appl. No.: 11/540,899

(22) Filed: Sep. 29, 2006

Related U.S. Application Data
(60) Provisional application No. 60/722,255, filed on Sep. 29, 2005.

(51) Int. Cl. G01N 27/26

(52) U.S. Cl. 204/400

(57) ABSTRACT

A microelectrode assembly for bio-stimulating and/or bio-sensing a target tissue includes a substrate having a first side and a second side, an array of microelectrodes, each of the microelectrodes including a nano-wire embedded within the substrate and extending from a proximal end at the first side to a distal end at the second side, each nano-wire having a diameter less than 1 μm. The substrate with the embedded nano-wires is fluid impermeable. The proximal ends of the nano-wires are adapted to be connected to an electronic device and the distal ends are adapted to be disposed in a biological environment for bio-stimulating a target tissue and/or bio-sensing activities of the target tissue.

### RELATED APPLICATION

The present application claims the benefit of U.S. Provisional Application No. 60/722,255 filed on 29 Sep. 2005, the contents of which are incorporated in their entirety herein by reference.

### TECHNICAL FIELD

The present invention relates to microelectrode systems for in vivo and/or in vitro neuro-stimulation and neuro-sensing and microchip packaging, and methods of making the microelectrode systems. More particularly, the present invention relates to nano-scale microelectrode systems and methods of making the nano-scale microelectrode systems.

### BACKGROUND

A microelectrode system used in neuro-stimulation and neuro-sensing typically includes an array of microelectrodes used as signal sources or a sensor interface for generating or receiving electrical signals, thereby to stimulate or sense activities in tissues.

The microelectrodes in a neuro-stimulation or sensing device are typically connected to an electronic device, for example, a microchip, by interconnects. The electronic device must be protected in a fluid impermeable package and the interconnects are the only part of the device that penetrate through the fluid impermeable package. In the development of a microelectrode array embedded in a substrate, the substrate/electrode structure must resist fluid penetration to ensure the electronic device is not damaged by short circuiting or corrosion. Fluid penetration through the electrode or substrate structure can occur in one of the following ways: 1) through the electrode itself, 2) through the substrate, or 3) along the interface between the electrode and substrate. Appropriate material selection for the electrode and the substrate and appropriate manufacturing process are needed to produce a fluid impermeable microelectrode system.

One conventional microelectrode system includes an array of microelectrodes patterned on a top side of a two-dimensional, rigid substrate (e.g. silicon wafer). This approach is capable of producing small microelectrodes; however, the total number and size of the microelectrodes are limited by the need to pattern electrical leads, which are on the same side of the substrate, for each electrode. As a result, wide channels need to be constructed on the substrate to accommodate the individual electrical lead for each electrode. Thus the number of the electrodes in a unit area is limited.

In some instances, such as retinal prosthesis applications, the target tissue is curved, and the microelectrode array must conform to the target tissue structure to avoid damage to the tissue. The prior art microelectrode arrays generally fail to conform to a target tissue.

Therefore, there is need for an improved microelectrode system that overcomes one or more of the problems set forth above.

### SUMMARY

The present disclosure provides a microelectrode assembly used for neuro-stimulating and neuro-sensing devices and microchip packaging, and methods of making the microelectrode assembly. In one aspect, the microelectrode assembly for bio-stimulating and/or bio-sensing a target tissue includes a substrate having a first side and a second side, an array of microelectrodes, each of the microelectrodes including a nano-wire embedded within the substrate and extending from a proximal end at the first side to a distal end at the second side, each nano-wire having a diameter less than 1 μm. The substrate with the embedded nano-wires is fluid impermeable. The proximal ends of the nano-wires are adapted to be connected to an electronic device and the distal ends are adapted to be disposed in a biological environment for bio-stimulating a target tissue and/or bio-sensing activities of the target tissue. In one embodiment, the substrate is made from aluminum oxide and the nano-wires are made from platinum.

In another aspect, a method of making a microelectrode assembly having an array of microelectrodes for bio-stimulating and/or bio-sensing a target tissue includes providing a substrate having a first side and a second side and an array of nano-channels passing through the substrate from the first side to the second side, each of the nano-channels having a diameter less than 1 μm, depositing a layer of electrically conductive material on the first side, and electrodepositing an electrically conductive material into the array of nano-channels to fill the nano-channels from the second side to form the array of microelectrodes. In one embodiment, the substrate is made from aluminum oxide and the electrically conductive material for depositing into the nano-channels is platinum.

According to a further aspect of the present disclosure, an electronic system includes an electronic device and a fluid impermeable packaging system for packaging the electronic device. The fluid impermeable packaging system includes a microelectrode assembly as described above.

According to yet another aspect of the present disclosure, a method of making a microelectrode assembly having an array of microelectrodes for bio-stimulating and/or bio-sensing a target tissue includes providing a substrate having a first side and a second side and an array of nano-channels passing through the substrate from the first side to the second side, the substrate having a barrier layer disposed over the first side, each of the nano-channels having a diameter less than 1 μm, patterning the barrier layer to define a pattern for the array of microelectrodes, depositing a layer of electrically conductive material on the first side, and electrodepositing an electrically conductive material into the array of nano-channels to fill the nano-channels from the second side to form the array of microelectrodes.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic cross-sectional view of an embodiment of a microelectrode assembly according to the present disclosure;

FIG. 2 schematically shows a process of making the microelectrode assembly of FIG. 1;

FIG. 3 is a schematic view of an electrodeposition system for making the microelectrode assembly of FIG. 1;

FIGS. 4A-4F schematically show cross-sectional views different embodiments of the microelectrode assembly according to the present disclosure;

FIG. 5 shows views of different diagrams of potentiostatic current vs. time transients in nano-wire electrodeposition;

FIGS. 6A and 6B show diagrams of cyclic voltammetry data for platinum nano-wire electrodes (6A) and platinum planar disk electrodes (6B);

FIG. 7 is a schematic view of an assembly for making a microelectrode assembly using a substrate having a barrier layer according to one aspect of the present disclosure;

FIG. 8 is a schematic cross-sectional view of an embodiment of a microelectrode assembly according to the present disclosure;

FIG. 9A illustrates a microelectrode system including multiple microelectrode assemblies each microelectrode assembly including an array of nano-wires, and FIGS. 9B and 9C illustrate enlarged views of a microelectrode assembly of FIG. 9A;

FIG. 10 shows a microelectrode probe including a microelectrode assembly; and

FIG. 11 is a schematic cross-sectional view of an embodiment of an electronic system having a microelectrode packaging system according to the present disclosure.

### DETAILED DESCRIPTION OF THE PREFERRED EMBODIMENTS

The present disclosure provides a microelectrode assembly used for neuro-stimulating and neuro-sensing devices and microchip packaging, and methods of making the microelectrode assembly.

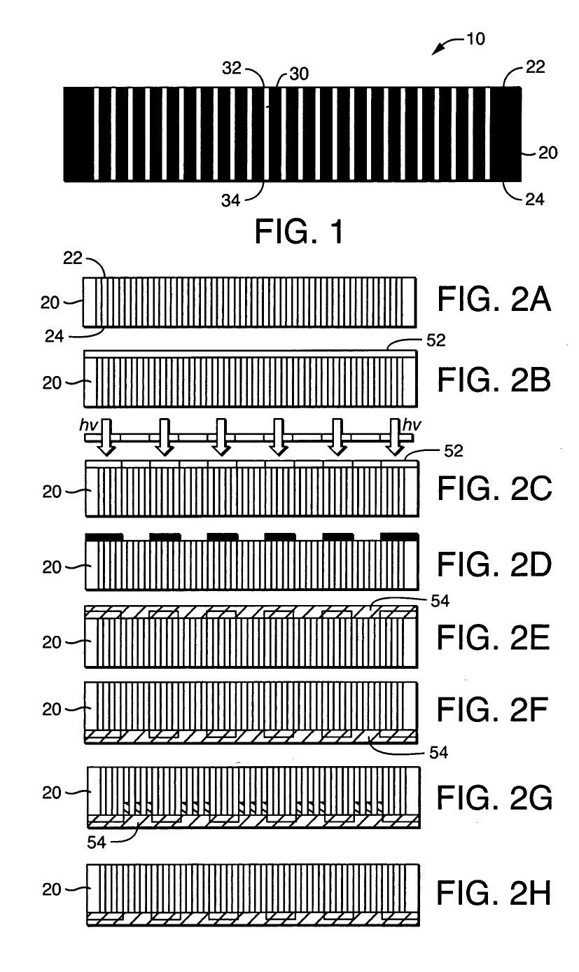

FIG. 1 illustrates a cross-sectional view of one embodiment of the microelectrode assembly. As shown in FIG. 1, the microelectrode assembly 10 includes a substrate 20, which includes a first side 22 and a second side 24, and an array of nano-wires 30 individually extending from a proximal end 32 at the first side 22 to a distal end 34 at the second side 24. The proximal ends 32 and the distal ends 34 may be disposed in the plane of the surfaces of the substrate 20 as shown in FIG. 1. Alternatively, the proximal ends 32 and the distal ends 34 may extend above or below the surfaces of the substrate 20. In one embodiment, the substrate 20 is made from a ceramic material, for example, aluminum oxide (crystalline aluminum oxide or polycrystalline aluminum oxide). In another embodiment, the substrate 20 is made from a flexible material, for example, polymer. The nano-wires 30 are made from an electrically conductive material, preferably platinum. The nano-wire 30 has a rod-like or wire-like shape with a cross-sectional diameter from a few nanometers to about one micrometer.

In one embodiment, the aluminurn oxide substrate 20 is about 60 μm thick and the diameter of the nano-wires 30 is about 50 nm. The size, spacing, and pattern of the nano-wires 30 can be different in different embodiments and can be controlled in the manufacturing process, which will be described in detail below. The substrate 20 with the embedded nano-wires 30 is fluid impermeable. The proximal ends 32 of the nano-wires 30 are adapted to be connected to an electronic device and the distal ends are adapted to be disposed in a biological environment for bio-stimulating a target tissue or bio-sensing activities of the target tissue. The microelectrode assembly 10 can be reversed, where the distal ends 34 are connected to the electronic device and the proximal ends 32 are disposed in the biological environment (e.g., in vivo or in vitro).

FIG. 2 schematically illustrates a process of making the microelectrode assembly 10 according to the present disclosure. A nano-channeled aluminum oxide substrate 20, which can be obtained in the market, is first provided as shown in step (a). In one embodiment, each nano-channel has a cross-sectional diameter from a few nanometers to about one micrometer. The nano-channeled substrate 20 is spin-coated with photoresist 52 on one side of the substrate (for example, the first side 22 as shown in FIG. 2) in step (b). A contact lithography mask with a pattern matching the desired microelectrode array geometry is placed over the photoresist 52, and the photoresist 52 is exposed, through the mask, to a UV light source to polymerize the photoresist 52 in step (c). The patterned photoresist 52 is developed to remove unwanted, unpolymerized photoresist, leaving the substrate 20 with a patterned photoresist layer on the first side 22 in step (d). A layer of conductive material 54 (for example, a metal such as Au, Ag, Cu, etc.) is deposited by sputtering or evaporation over the top of the photoresist to seal the bases of the nano-channels that have not been sealed by the photoresist in step (e).

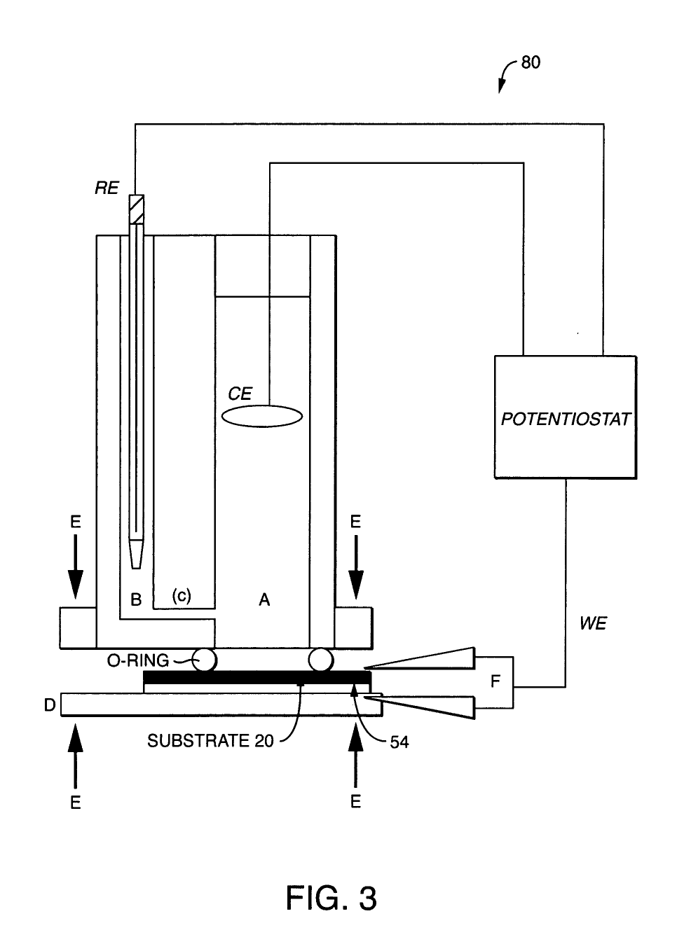

The substrate is placed with the conductive material layer 54 at the bottom of the substrate 20 onto an electrically conductive material plate, as shown in step (f) in FIG. 2 and in FIG. 3. An electrochemical cell is clamped over the openings of the nano-channels at the second side 24 of the substrate 20. In one embodiment, the cell is filled with aqueous ammonium hexachloroplatinate solution having a pH of approximately 7.4 to 7.8. In one embodiment, the solution composition is about 17 mM (NH₄)₂PtCl₆ and 150 mM H₂NaPO₄.

FIG. 3 schematically shows an electrodeposition system 80 used to electrodeposit platinum into the nano-channels to form the array of nano-wires 30. As shown in FIG. 3, the electrodeposition system 80 includes a three-electrode electrochemical system connected to a computer controlled potentiostat. The electrodeposition system 80 includes an electrochemical cell, which includes one larger diameter electrolyte column (A) and one smaller diameter electrolyte column (B), each connected to one another at the base via a cross-drilled Luggin capillary (C). The substrate is placed onto a copper plate (D), with the openings of the nano-channels facing up, and a polymer o-ring is placed on the top of the substrate 20. The column (A) is fixed over the o-ring using a steel spring-clamp (E). This provides a water-tight seal between the electrochemical cell and the substrate 20. The column (A) is filled with plating solution (the aqueous ammonium hexachloroplatinate solution). A toothless copper alligator clip (F) is used to make electrical contact between the working electrode lead (WE) and the conductive material layer 54 of the substrate 20. A platinum mesh counter electrode (CE) is suspended through the top opening of the larger column (A). A Ag/AgCl reference electrode (RE) is placed in the smaller-barreled column (B) of the cell. The cross-drilled Luggin capillary (C) allows for accurate potential measurement without disrupting the field between the working and counter electrodes. The reference electrode was tested vs. standard calomel electrode to confirm accuracy of measurements and consistency before the electrodeposition of platinum.

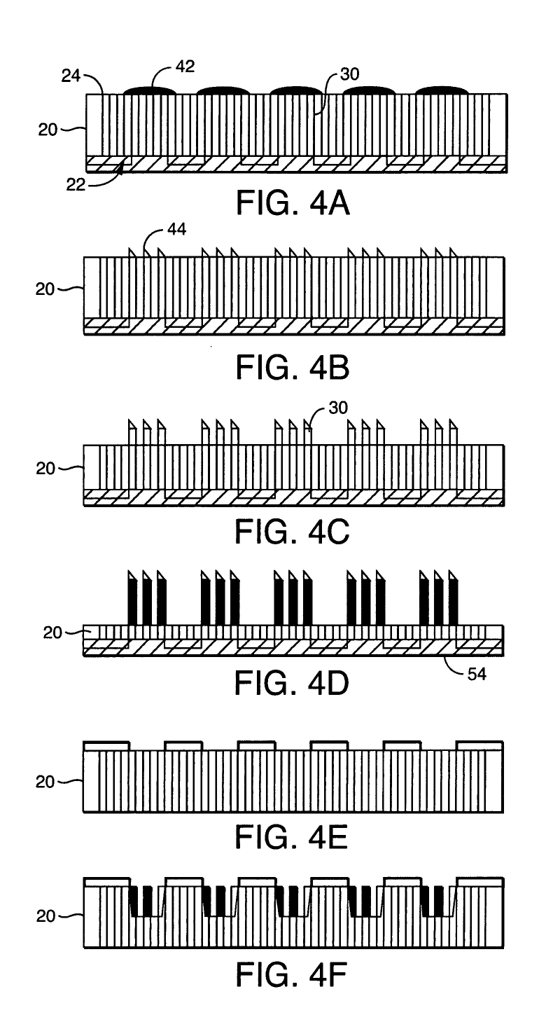

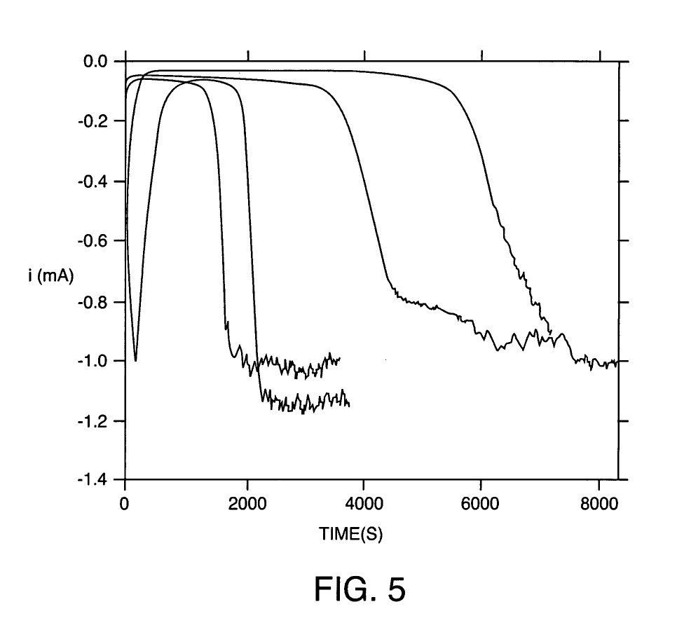

According to one embodiment, under continuous stirring, platinum is potentiostatically deposited between −0.4 V to −0.6 V vs. Ag/AgCl, depending on the exact cell conditions. The electrolyte should be replaced after the efficiency of deposition is substantially decreased, for example, 50% platinum ions being consumed. In one example, platinum is deposited in 30 minutes intervals as shown in step (g) in FIG. 2. After completion of each 30 minutes interval, the electrolyte is replaced with fresh electrolyte solution and the procedure is repeated. Current vs. time plots can be collected for each potentiostatic deposition, and overlayed for comparison as shown in FIG. 5. A significant increase in current magnitude indicates that the platinum has filled through the substrate as shown in step (h) in FIG. 2, and the deposition is no longer geometrically confined by the nano-channels. At this point, in one embodiment, the deposition can be continued to form a continuous patch 42 of platinum over a few nano-wires as shown in FIG. 4A, or form a disc over each electrode, or, alternatively, the deposition can be terminated leaving an array of nano-scale protrusions 44 at each electrode site as shown in FIG. 4B, or leaving an array of nano-wires without extending above the top surface of the substrate 20.

The substrate 20 with embedded nano-wires 30 are then mechanically polished by using a sharp blade or simply dragging across a polishing surface, or other mechanical polishing processes.

The second side 24 of the aluminum oxide substrate 20 can be etched to partially reveal the nano-wires 30 as shown in FIG. 4C and FIG. 4D. The etching can be performed in either basic or acidic solutions. Basic solutions include KOH and NaOH solutions. Concentrations can range from 50 mM to 5 M. Increasing the concentration causes more rapid and less controlled etching of the substrate 20. In the etching process, the substrate 20 may be mounted on a rotating stage or else stirring of the solution may be used to prevent accumulation of etching byproducts at the array surface, which might cause inhomogeneities.

Another method of etching the substrate 20 is by potential cycling or potential pulsing. The second side 24 of the substrate 20 is immersed in an aqueous solution and the potential on the nano-wires 30 can be set to the potential for hydrogen or hydroxyl plating. The potential can then be swept or stepped back to the open circuit potential. The resulting release of hydroxyl or hydrogen into the local solution etches the substrate 20. Impedance measurements can subsequently be performed to assess the change in the surface area of the nano-wires 30 revealed from the substrate 20.

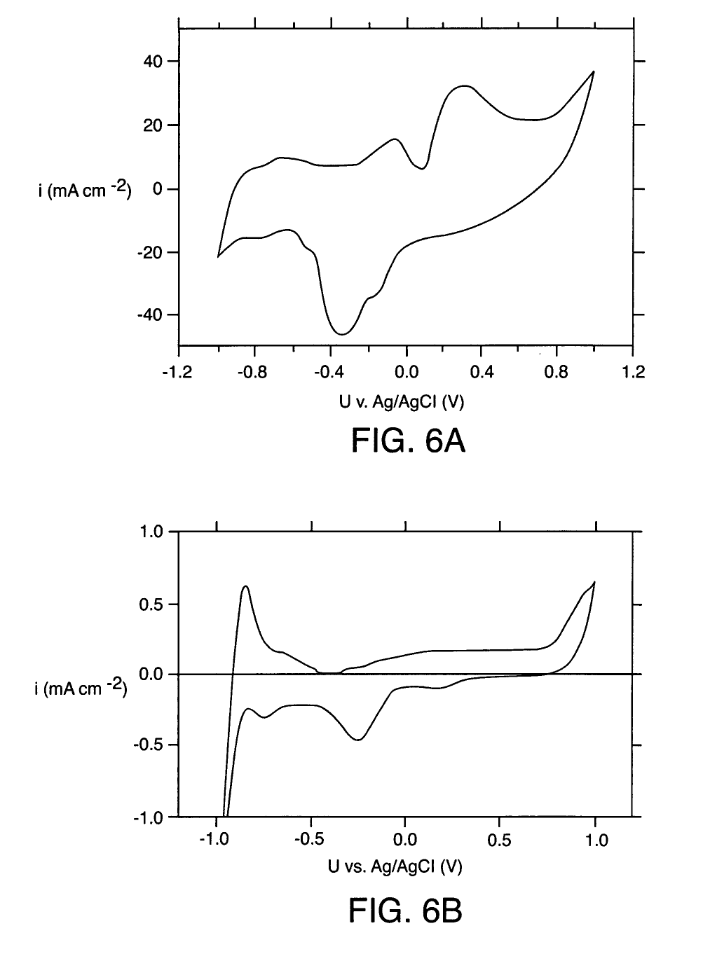

FIG. 6A and FIG. 6B show a comparison of cyclic voltammagrams for nano-wire electrode (FIG. 6A) and flat platinum disk electrode (FIG. 6B). Data has been normalized by the 2-dimensional surface area that the electrode occupies on the supporting substrate.

A cyclic voltammogram applies a potential (in volts) to the microelectrode surface and measures the resulting current response at the electrode-electrolyte interface. The voltage is swept, in a cyclic manner, over a range of potentials and the recorded data is plotted as a hysteresis loop of current vs. voltage (FIG. 6A and FIG. 6B). For the same applied potential, a microelectrode having a larger surface area will have a larger current response, because current scales with area (although the scaling may be non-linear).

In electrochemistry, normalizing the current by dividing it by the electrode surface area, i.e. current density (A cm⁻²), is a commonly accepted practice for purposes of comparison of electrodes with different geometries, different compositions, etc. As such, two surface area terms have been defined in electrochemsitry: geometric surface area and real surface area. Geometric surface area refers to the two-dimensional, projected area which an electrode occupies. For example, the geometric surface area of a cone sitting on its base is a circle of radius, r (the base of the cone). The real surface area refers to the actual physical surface area of the electrode, accounting for surface roughness, i.e. contributions to surface area from the third-dimension.

In developing a neuro-stimulating array which must fit within a confined spaced, the geometric area of each electrode will define the number of electrodes that can be placed inside a confined space. However, the current that can be delivered/injected (for some fixed potential, U_{applied}) by each electrode changes with real surface area (although the exact scaling is difficult to determine as it will be affected by the tortuosity of surface roughness features). For example, if two electrodes E1 and E2 of the same geometric surface area are tested, E2 having a larger real surface area than E1 (i.e. E2 has more surface roughness), to generate an equal amount of current from both electrodes, a larger potential need to be applied to E1 as compared to E2.

Referring to FIGS. 6A and 6B, the cyclic voltammograms in FIG. 6A and FIG. 6B plot the current density responses of a platinum nanowire microelectrode and a planar platinum disk electrode, in phosphate buffered saline (PBS) solution, recorded at a scan rate of 100 mV/s and scanned over the potential limits from −1.0 V to 1.0 V vs. Ag/AgCl reference electrode. For both plots, the current was divided by the geometric area of the electrode. Current was divided by real surface area to demonstrate that two microelectrodes occupying the same area on a microelectrode array grid are capable of generating significantly different current magnitudes for the same applied potential (i.e. driving force). The data shows that the nano-wire microelectrode can generate larger currents for the same applied potential. In other words, the nano-wire microelectrode is more efficient at injecting charge to the targeted tissue/cell.

The evaporated/sputtered metal 54 may be etched away to reveal the base of the electrodes. FIG. 4E illustrates one embodiment, in which the metal layer 54 (shown in FIG. 4D) is removed by etching, leaving the patterned photoresist on the first side 22 of the substrate 20. The first side 22 of the substrate 20 may also be partially etched away to partially reveal the nano-wires 30 as shown in FIG. 4F.

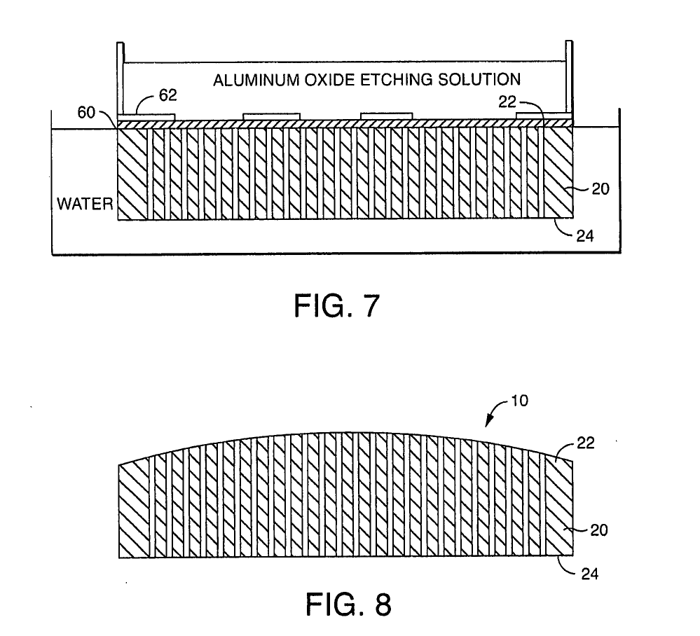

In the process of manufacturing nano-channeled aluminum oxide substrates, most of the nano-channeled aluminum oxide substrates are first manufactured with an aluminum oxide barrier layer at one side of the substrates. Typically, the barrier layer is removed before the nano-channeled aluminum oxide substrates enter the market. According to one aspect of the present invention, the microelectrode assembly may be manufactured with a nano-channeled aluminum oxide substrate that has an intact barrier layer 60 as shown in FIG. 7. The process of making the microelectrode assembly using the nano-channeled aluminum oxide substrate with the barrier layer is similar to the above described process. The barrier layer 60 is first patterned using a photolithography process. Photoresist 62 is first spin-coated onto the barrier layer 60. The photoresist 62 is then exposed to the UV light through a mask with a pattern and then developed, leaving the barrier layer exposed at areas where the microelectrodes will be. The substrate 20 is then clamped between two electrolyte chambers. The chamber facing the photoresist covered side of the substrate 20 is filled with aluminum oxide etching solution, while the chamber facing the nano-channeled side is filled with distilled water. The etchant only attacks the aluminum oxide barrier layer at areas not shielded by the photoresist 62. At those areas, the barrier layer is etched away until the nano-channels are exposed to the etchant. At this point, the distilled water held in the opposite chamber neutralizes the etchant, thus terminating the etching process before the nano-structure can be attacked. After the barrier layer is patterned to expose the nano-channels, a layer of metal is evaporated/sputtered overtop of the photoresist side of the substrate, and the same electrodeposition process as described above using the substrate without the barrier layer can be used to electrodeposit the platinum into the nano-channels to form the nano-wires. Using the nano-channeled aluminum oxide substrates with the aluminum oxide barrier layer is economically advantageous because the process of removing the barrier layer is eliminated. Another advantage is that the aluminum oxide barrier layer improves the fluid impermeability of the substrate.

The nano-channeled substrates (which are available in the market) may have a thickness equal to or greater than 50 μm and nano-channel diameters ranging from 5 nm to 200 nm. The array of the microelectrode assembly may include a single nano-wire or multiple nano-wires in the substrate, or one or more micro-scaled “patches” of nano-wires which are connected electrically in parallel at their bases. The dimensions of the nano-wires including the diameter of the nano-wire and the spacing between the nano-wires, the number of the nano-wires, and the dimensions of the substrate may be tailored to meet the requirements of a specific application.

In one embodiment, the electrodeposited platinum nano-wires comprise polycrystalline platinum and the substrate is polycrystalline aluminum oxide. From a fluid permeability perspective, those materials are highly resistant to water penetration. Susceptibility to fluid permeation is not only a function of the material type, but also of the material thickness. Nano-channeled aluminum oxide substrate has been fabricated with a thicknesses greater than 50 μm, which is on the order required for packaging for electronics.

With the appropriate selection of materials for the electrodes and substrate, the only pathway for fluid permeation is along the interface between the electrodes and substrate. In general, the electrodeposition process used to create the nano-wires results in a complete filling of the channels in the substrate. For the case of platinum nano-wires, platinum complexes used for deposition, such as [PtCl₆]²⁻, adsorb on alumina surfaces thereby contributing to complete filling of the channels. Sintering may also be used to improve the integrity of the electrode/substrate interface.

In the situation that the microelectrode assembly is used in neuro-stimulating/neuro-sensing, the curvature of tissue, for example, the curvature of the retina may require that the microelectrode assembly be curved and conforms to the shape of the tissue. According to one aspect of the invention, the microelectrode assembly is fabricated with a relatively thick substrate and then is mechanically or chemical-mechanically polished to create a surface with a suitable radius of curvature as shown in FIG. 8.

An alternative approach to addressing the radius of curvature issue is to form the substrate in an aluminum film that has the desired radius of curvature on one side of the substrate. The pre-curved nano-channeled substrate with geometries conforming to the target tissue is subsequently filled with an electrically conductive material to form the nano-wires.

The end surface areas of the platinum microelectrodes revealed out of the substrate at one side of the substrate can be tailored. In one form, the nano-wires in the microelectrodes are flush with the surface of the substrate and hence have an exposed area that is related to the nano-wire diameter and the number of nano-wires in the substrate. The end surface area of the microelectrodes can be increased by partially etching the substrate to expose a given length of the nano-wires. The electrode surface area can be increased systematically by controlling the amount of substrate etching. According to another aspect, the morphology of electrodeposited platinum nano-wires is dependent on the deposition conditions, and under certain conditions the deposited platinum is highly porous. Thus the surface area of the microelectrodes can be increased by depositing highly porous platinum for the end-segments of the nano-wires.

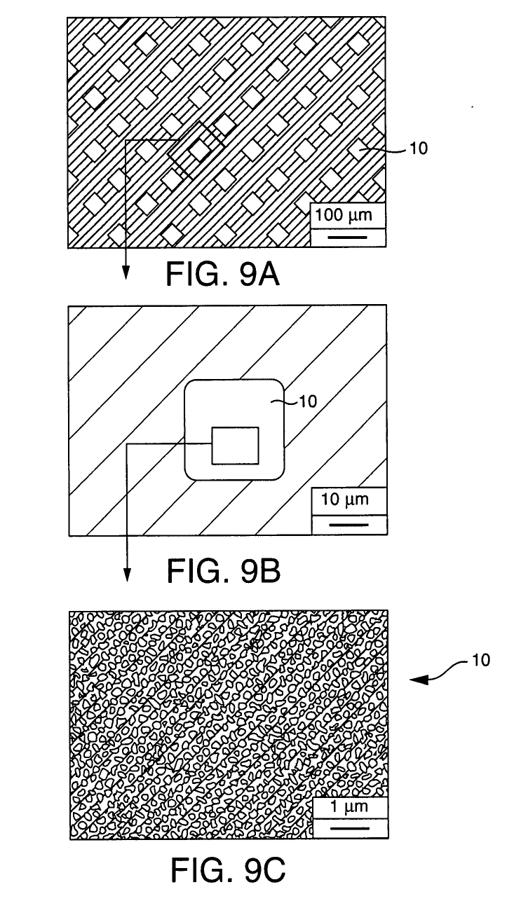

FIG. 9A illustrates a microelectrode system which includes multiple microelectrode assemblies 10 as described above. Each microelectrode assembly 10 is 50 μm×50 μm square with approximately 100 μm edge-to-edge spacing between two microelectrode assemblies 10 arranged in a square pattern. FIG. 9B shows an enlarged view of one microelectrode assembly 10 and FIG. 9C shows a further enlarged view of a part of the microelectrode assembly 10 to show the nano-wires.

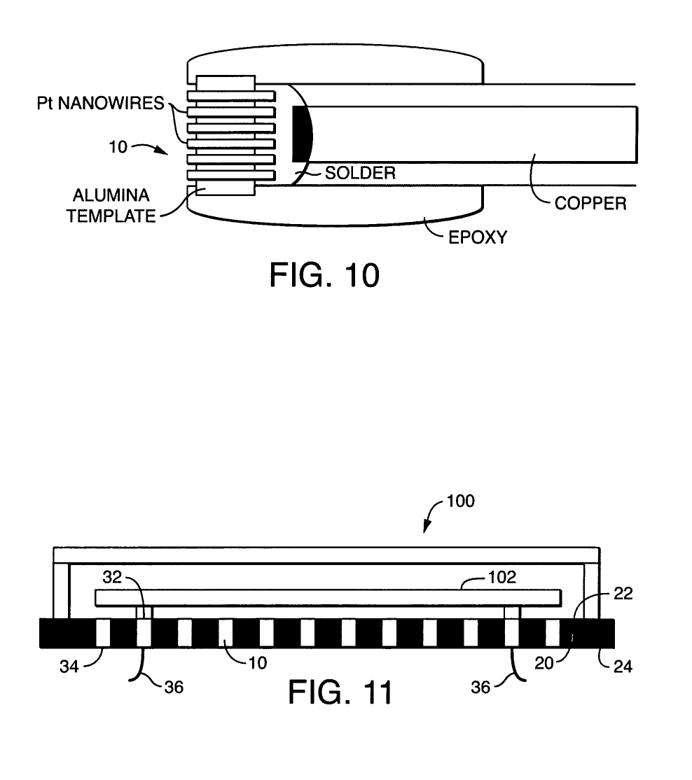

FIG. 10 shows a microelectrode probe which includes a microelectrode assembly 10 connected to a copper wire by solder.

The microelectrode assembly may be used for packaging electronic devices. FIG. 11 illustrates an electronic system 100, which has an electronic device 102 (e.g., a microchip) packaged with a microelectrode system which includes multiple microelectrode assemblies 10 constructed according to the present disclosure. The proximal ends 32 of at least one microelectrode assembly 10 at the first side of the substrate 22 are connected to the electronic device 102 and the distal ends 34 at the second side of the substrate 24 connected to leads 36 or disposed in a biological environment for bio-stimulating a target tissue or bio-sensing activities of the target tissue. Because the nano-wires 30 penetrate through the supporting substrate 20, the leads can be constructed and patterned on the backside (i.e., the second side) of the substrate 20, thereby eliminating the problems associated with having electrodes, leads, and contacts on the same side of the packaging substrate.

The microelectrode assembly may be used in biomedical applications where electrical neuro-stimulation/sensing is implemented/required. This may include but is not limited to retinal prosthesis applications, cochlear implant applications, cardiac stimulation, cortical stimulation, and other possible implantable neurostimulatory or neurosensing device applications. The microelectrode assembly may also be used in research settings/applications, for example, measurement, mapping, stimulation, and sensing of neural activity or possibly chemical activity of cell cultures.

Preliminary helium leak tests using an ALCATEL™ ASM series helium leak test system were performed on circular nano-wire ceramic substrate pieces. Samples were positioned over a vacuum port connected to a mass spectrometer, calibrated for helium detection. Vacuum was applied on one side, while the opposite side of the substrate was exposed to helium gas. Spectrometer helium leak detection readings for three of the four samples were less than 10⁻¹¹ ppm.

Nano-channeled aluminum oxide substrates are typically two-dimensional. Curved nano-channeled aluminum oxide substrates can be formed. Soft polymer substrate with nano-channels can also be used to form flexible arrays.

The nano-channeled aluminum oxide substrate can be substituted with other nano-porous substrate materials. The limiting criteria are that: 1) the nano-channels be continuous from one side of the substrate to the other, 2) the nano-channels are non-networking between one another, 3) the substrate is resistant to water permeation, 4) the substrate is electrically insulating.

The diameter and length of the nano-channels can be varied. Channel diameter can vary from 1 nm to hundreds of nanometers. Channel length will be dependent on substrate thickness. The thickness should be on the order of micrometers (1-1000).

Platinum nano-wires can be substituted with other metals, metal alloy or metal oxide composition used for neural stimulation or neural sensing. This includes but is not limited to: platinum, platinum oxide, iridium, iridium oxide, platinum-iridium alloys, tantalum and tantalum oxide, carbon, and ruthenium.

The neural interface side at distal ends of the nano-wires of the microelectrode assembly can be tailored into different shapes. In one embodiment, the nano-wires comprising a single electrode are plated through the substrate and capped over to form a continuous patch of platinum over the top of each nano-wire. In another embodiment, the nano-wires are capped over and the caps are mechanically removed by polishing or milling to make each electrode an array of discrete nano-discs, coplanar with the substrate surface. In a further embodiment, the nano-wires are deposited so that the terminals are coplanar with the top surface of the nano-channeled substrate. In yet another embodiment, the substrate is partially etched to partially reveal the nano-wires. The surface area of the microelectrodes can be increased to a predefined surface area by controlling the etching procedure. According to another aspect of the invention, the surface features described above also can be used on the other side of the microelectrode assembly. For example, the metal layer 54 (in FIG. 4D) can be removed and the substrate can be partially etched to partially reveal the nano-wires. For another example, the metal layer 54 can be patterned to form metal patches connected to the nano-wires.

While the claimed invention has been described in detail and with reference to specific embodiments thereof, it will be apparent to one of ordinary skill in the art that various changes and modifications can be made to the claimed invention without departing from the spirit and scope thereof. Thus, for example those skilled in the art will recognize, or be able to ascertain, using no more than routine experimentation, numerous equivalents to the specific substances and procedures described herein. Such equivalents are considered to be within the scope of this invention, and are covered by the following claims.

What is claimed is:

1. A microelectrode assembly for bio-stimulating and/or bio-sensing a target tissue comprising:
a substrate having a first side and a second side; and
an array of microelectrodes, each of said microelectrodes including a nano-wire embedded within said substrate and extending from a proximal end at said first side to a distal end at said second side, each nano-wire having a diameter less than 1 μm,
wherein said substrate with said embedded nano-wires is fluid impermeable, and wherein said proximal ends are adapted to be connected to an electronic device and said distal ends are adapted to be disposed in a biological environment.

2. A microelectrode assembly according to claim 1, wherein said substrate is made from a biocompatible material.

3. A microelectrode assembly according to claim 1, wherein said substrate is made from a ceramic material.

4. A microelectrode assembly according to claim 1, wherein said substrate is made from aluminum oxide.

5. A microelectrode assembly according to claim 1, wherein said substrate is made from a polymer.

6. A microelectrode assembly according to claim 1, wherein said nano-wires are made from a material selected from a group consisting of platinum, platinum oxide, iridium, iridium oxide, platinum-iridium alloy, tantalum, tantalum oxide, carbon, and ruthenium.

7. A microelectrode assembly according to claim 1, wherein said nano-wire has a diameter equal to or less than 200 nm.

8. A microelectrode assembly according to claim 1, wherein said substrate has a thickness equal to or greater than 50 μm.

9. A microelectrode assembly according to claim 1, wherein said array of microelectrodes are distributed in said substrate with a pattern.

10. A microelectrode assembly according to claim 1, wherein said substrate has a curvature that conforms to a curvature of the target tissue.

11. A microelectrode assembly according to claim 1, wherein said nano-wires extend out of said substrate at at least one of said first side and said second side of said substrate.

12. A method of making a microelectrode assembly having an array of microelectrodes for bio-stimulating and/or bio-sensing a target tissue comprising:
providing a substrate having a first side and a second side and an array of nano-channels passing through said substrate from said first side to said second side, each of said nano-channels having a diameter less than 1 μm;
depositing a layer of electrically conductive material on said first side; and
electrodepositing an electrically conductive material into said array of nano-channels to fill said nano-channels from said second side to form said array of microelectrodes.

13. A method according to claim 12, wherein, before said step of depositing a layer of electrically conductive material on said first side, said method further comprising:
depositing a layer of photoresist on said first side; and
patterning said layer of photoresist to define a pattern for said array of microelectrodes.

14. A method according to claim 12, wherein said substrate is made from a ceramic material.

15. A method according to claim 12, wherein said substrate is made from aluminum oxide.

16. A method according to claim 12, wherein said electrically conductive material for electrodepositing into said nano-channels is selected from a group consisting of platinum, platinum oxide, iridium, iridium oxide, platinum-iridium alloy, tantalum, tantalum oxide, carbon, and ruthenium.

17. A method according to claim 16, wherein said step of electrodepositing an electrically conductive material into said array of nano-channels to fill said nano-channels from said second side to form said array of microelectrodes includes immersing said array of nano-channels in an ammonium hexachloroplatinate solution and connecting said layer of electrically conductive material to a voltage source.

18. A method according to claim 12 further comprising at least partially removing the layer of the electrically conductive material.

19. A method according to claim 18 further comprising partially removing the substrate from the first side of the substrate to partially reveal the microelectrodes.

20. A method according to claim 12 fturther comprising partially removing the substrate from the second side of the substrate to partially reveal the microelectrodes.

21. A method according to claim 12, wherein said substrate has a curvature at at least one of said first side and said second side that conforms to a curvature of the target tissue.

22. A method according to claim 12 further comprising machining said substrate with said microelectrodes to form a curvature at at least one of said first side and said second side, and wherein said curvature conforms to a curvature of said target tissue.

23. A method according to claim 12, wherein said substrate includes a barrier layer at said first side, and wherein said method further comprising patterning said barrier layer to define a pattern for said array of microelectrodes.

24. An electronic system comprising:
an electronic device;
a fluid impermeable packaging system for packaging said electronic device including:
a substrate having a first side and a second side; and
an array of microelectrodes, each of said microelectrodes including a nano-wire embedded within said substrate and extending from a proximal end at said first side to a distal end at said second side, each nano-wire having a diameter less than 1 μm,
wherein said proximal ends of said microelectrodes are connected to said electronic device and said distal ends of said microelectrodes are adapted to be disposed in a biological environment,
and wherein said substrate with said embedded nano-wires is fluid impermeable.

25. An electronic system according to claim 24, wherein said substrate is made from a ceramic material.

26. An electronic system according to claim 24, wherein said substrate is made from aluminum oxide.

27. An electronic system according to claim 24, wherein said nano-wires are made from is a material selected from a group consisting of platinum, platinum oxide, iridium, iridium oxide, platinum-iridium alloy, tantalum, tantalum oxide, carbon, and ruthenium.

28. An electronic system according to claim 24, wherein said second side of said substrate is opposite to said first side of said substrate.

29. An electronic system according to claim 24, wherein said nano-wires extend out of said substrate at at least one of said first side and said second side of said substrate.

30. An electronic system according to claim 24, wherein said array of microelectrodes are distributed in said substrate with a pattern.

31. A method of making a microelectrode assembly having an array of microelectrodes for bio-stimulating and/or bio-sensing a target tissue comprising:
providing a substrate having a first side and a second side and an array of nano-channels passing through said substrate from said first side to said second side, said substrate having a barrier layer disposed over said first side, each of said nano-channels having a diameter less than 1 μm;
patterning said barrier layer to define a pattern for said array of microelectrodes;
depositing a layer of electrically conductive material on said first side; and
electrodepositing an electrically conductive material into said array of nano-channels to fill said nano-channels from said second side to form said array of microelectrodes.

32. A microelectrode system includes multiple microelectrode assemblies of claim 1.
